(19) United States
(12) Patent Application Publication
(10) Pub. No.: US 2013/0276111 A1
(43) Pub. Date: Oct. 17, 2013

(54) SYSTEM, METHOD, AND COMPUTER PROGRAM PRODUCT FOR PROVIDING AT LEAST ONE STATISTIC ASSOCIATED WITH A POTENTIALLY UNWANTED ACTIVITY TO A USER

(71) Applicant: Gaith S. Taha, Aylesbury (GB)

(72) Inventor: Gaith S. Taha, Aylesbury (GB)

(21) Appl. No.: 12/019,552

(22) Filed: Jan. 24, 2008

(51) Int. Cl. G06F 21/00

(52) U.S. Cl. 726/23

(57) ABSTRACT

A system, method, and computer program product provide at least one statistic associated with a potentially unwanted activity to a user. In use, a potentially unwanted activity is identified. Further, at least one statistic associated with at least one characteristic of the potentially unwanted activity is determined. Additionally, the at least one statistic is provided to a user.

### FIELD OF THE INVENTION

The present invention relates to unwanted activity, and more particularly to identifying potentially unwanted activity.

### BACKGROUND

Traditionally, unwanted activity has been identified utilizing security systems. For example, such security systems have included malware scanners, firewalls, etc. for identifying unwanted activity associated with malware, etc. However, such security systems have conventionally exhibited various limitations when activity is identified as potentially unwanted.

For example, security systems customarily block or allow activity associated with an application utilizing blacklists and/or whitelists. Such blacklists/whitelists are usually entirely created on behalf of a user, but are sometimes also configurable by the user to allow exceptions. Generally, security systems have allowed the user to indicate an exception for an application solely based on an origin of the application. However, the origin of the application may not provide the user with enough information to make an informed decision on whether to create an exception.

There is thus a need for overcoming these and/or other issues associated with the prior art.

### SUMMARY

A system, method, and computer program product provide at least one statistic associated with a potentially unwanted activity to a user. In use, a potentially unwanted activity is identified. Further, at least one statistic associated with at least one characteristic of the potentially unwanted activity is determined. Additionally, the at least one statistic is provided to a user.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 illustrates a method for providing at least one statistic associated with a potentially unwanted activity to a user, in accordance with another embodiment.

FIG. 4 illustrates a method for allowing or blocking a potentially unwanted activity based on an indication received by a user, in accordance with yet another embodiment.

FIG. 5 illustrates a graphical user interface for displaying a message associated with a potentially unwanted activity to a user, in accordance with still yet another embodiment.

FIG. 6 illustrates a pictorial representation indicating at least one statistic associated with a potentially unwanted activity, in accordance with another embodiment.

FIG. 7 illustrates a graph indicating at least one statistic of a potentially unwanted activity to a user, in accordance with yet another embodiment.

### DETAILED DESCRIPTION

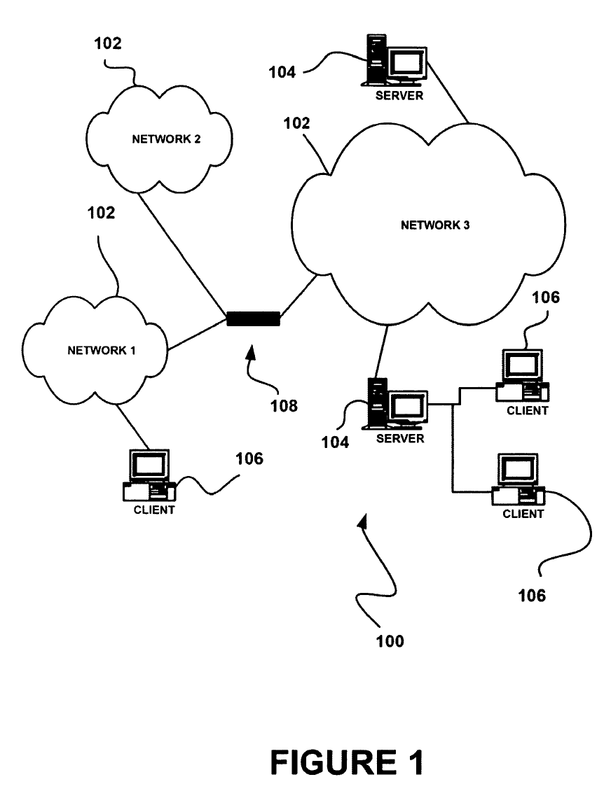

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

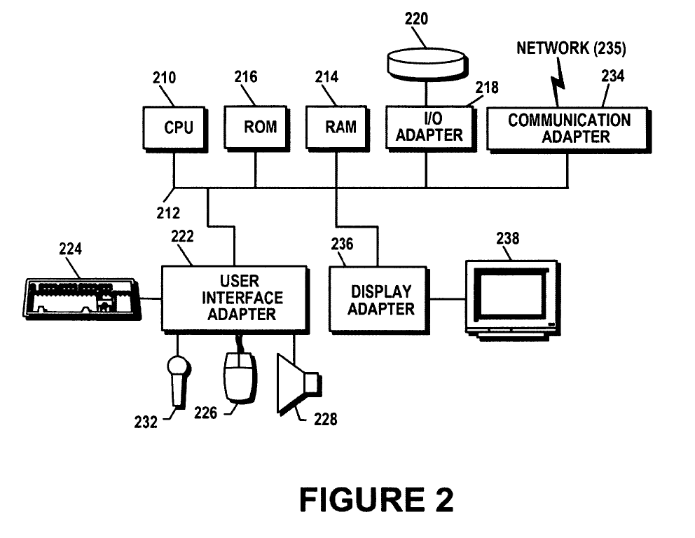

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

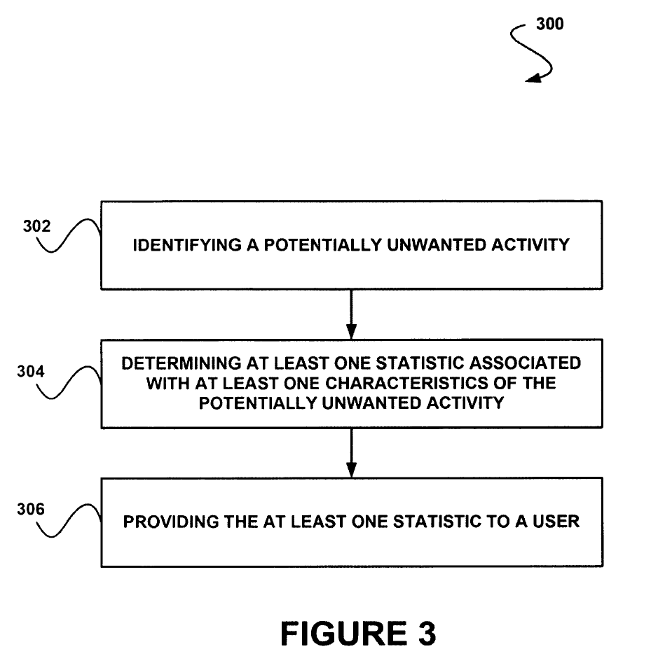

FIG. 3 illustrates a method 300 for providing at least one statistic associated with a potentially unwanted activity to a user, in accordance with another embodiment. As an option, the method 300 may be carried out in the context of the architecture and environment of FIGS. 1 and/or 2. Of course, however, the method 300 may be carried out in any desired environment.

As shown in operation 302, a potentially unwanted activity is identified. In the context of the present description, the potentially unwanted activity may include any activity that is potentially unwanted. For example, the potentially unwanted activity may include activity that has not been identified as wanted activity or unwanted activity. As an option, the potentially unwanted activity may be associated with an application. Furthermore, as yet another option, the application may initiate the potentially unwanted activity.

In one embodiment, the potentially unwanted activity may include activity potentially associated with malware. For example, the malware may be capable of initiating unwanted activity. Further, as yet another option, the malware may be associated with an application, a script, a virus, a worm, a trojan, a rootkit, a backdoor, spyware, adware, a logger, a dialer, and/or any other data. For example, the malware may be capable of initiating an activity that may be damaging, destructive, detrimental, harmful, invasive, intrusive, malicious, mischievous, subversive, unsafe, etc. As an option, the unwanted activity may include any activity associated with the malware.

In another embodiment, the potentially unwanted activity may include a potentially wanted activity. As an option, the wanted activity may include any activity associated with an application and/or data. For example, the application and/or data may be capable of initiating an activity that may be beneficial, benevolent, benign, desirable, harmless, helpful, innocuous, etc.

Furthermore, in yet another embodiment, the potentially unwanted activity may be identified by analyzing, comparing, examining, scanning, etc. activity. In still yet another embodiment, the potentially unwanted activity may be identified via blacklisting. As an option, blacklisting may include identifying activity as potentially unwanted activity if the activity is included on a blacklist. Optionally, the blacklist may be included in a database, a hash, a file, and/or any data structure. In another embodiment, the potentially unwanted activity may be identified via whitelisting. As an option, whitelisting may include activity as potentially wanted if the activity is included on a whitelist.

Additionally, in another embodiment, the potentially unwanted activity may be identified via signature scanning. As an option, signature scanning may include matching characteristics of the potentially unwanted activity against a list of signatures. For example, the list of signatures may include a portion of application code, behavior, actions, etc. associated with known potentially unwanted activity. In yet another embodiment, the potentially unwanted activity may be identified utilizing heuristics.

Still yet, the potentially unwanted activity may be identified utilizing a security system. For example, the security system may include a scanner, firewall, etc. Further, the potentially unwanted activity may be identified utilizing any of the devices described above with respect to FIGS. 1 and/or 2.

As shown in operation 304, at least one statistic associated with at least one characteristic of the potentially unwanted activity is determined. In one embodiment, the characteristic may include any characteristic capable of being associated with the potentially unwanted activity. As an option, the characteristic may include at least one characteristic of the application associated with the potentially unwanted activity. As another option, the characteristic may include at least one behavioral characteristic of the potentially unwanted activity.

In yet another embodiment, the statistic may be associated with the characteristic of the potentially unwanted activity in any desired manner. As an option, the statistic may include any statistical representation associated with the characteristic of the potentially unwanted activity. Optionally, the statistic may include a percentage that the characteristic of the potentially unwanted activity is unwanted and/or a percentage that the characteristic of the potentially unwanted activity is wanted. For example, the statistic may indicate that the characteristic associated with the potentially unwanted activity is unwanted 75% of the time, and wanted 25% of the time.

In still yet another embodiment, determining the statistic may include ascertaining, calculating, resolving, etc. As an option, the statistic may be determined by comparing the characteristic of the potentially unwanted activity against a predetermined set of characteristics. Optionally, the predetermined set of characteristics may be included in a database, a file, a hash, a list, or any other data structure. Further, as yet another option, each of the characteristics in the set of characteristics may be associated with a predetermined statistic indicating a percentage that the characteristic has previously been associated with unwanted activity and/or a predetermined statistic indicating a percentage that the characteristic has previously been associated with wanted activity. In addition, as an option, the statistic may be an aggregate of a plurality of statistics associated with the potentially unwanted activity.

As another option, the statistic may be determined based on previous instances of unwanted activity associated with the characteristic of the potentially unwanted activity. Such previous instances of unwanted activity may include any activity previously identified as unwanted that is associated with the characteristic of the potentially unwanted activity. Just by way of example, a number of the previous instances of unwanted activity may be divided by a total number of instances of all activity associated with the characteristic, for determining the statistic. In this way, the statistic may indicate the percentage that the characteristic has previously been associated with unwanted activity.

In another embodiment, the statistic may be determined based on previous instances of wanted activity associated with the characteristic of the potentially unwanted activity. Such previous instances of wanted activity may include any activity previously identified as wanted that is associated with the characteristic of the potentially unwanted activity. Just by way of example, a number of the previous instances of wanted activity may be divided by a total number of instances of all activity associated with the characteristic, for determining the statistic. Accordingly, the statistic may indicate the percentage that the characteristic has previously been associated with wanted activity. Of course, however, the statistics may be identified in any desired manner.

As shown in operation 306, the at least one statistic is provided to a user. Such user may include any user of a device. For example, the user may include an administrator, a user of a device on which the potentially unwanted activity was identified, etc.

In one embodiment, the statistic may be provided to the user utilizing a message. As an option, the message may include an alert, a pop-up, a notification, etc. Optionally, the message may be provided (e.g. displayed, etc.) to the user utilizing a graphical user interface, a textual interface, and/or any other interface capable of providing the message to the user.

In another embodiment, the message may allow the user to indicate whether the potentially unwanted activity is a wanted activity or an unwanted activity. Optionally, indicating that the potentially unwanted activity is wanted may include an indication to allow, approve, authorize, confirm, sanction, etc. the potentially unwanted activity. Further, as yet another option, indicating that the potentially unwanted activity is unwanted may include an indication to block, cancel, deny, disallow, prohibit, prevent, and/or refuse the potentially unwanted activity. In this way, the user may utilize the statistic associated with the characteristic of the potentially unwanted activity for determining whether to indicate that the potentially unwanted activity is wanted or unwanted.

More illustrative information will now be set forth regarding various optional architectures and features with which the foregoing technique may or may not be implemented, per the desires of the user. It should be strongly noted that the following information is set forth for illustrative purposes and should not be construed as limiting in any manner. Any of the following features may be optionally incorporated with or without the exclusion of other features described.

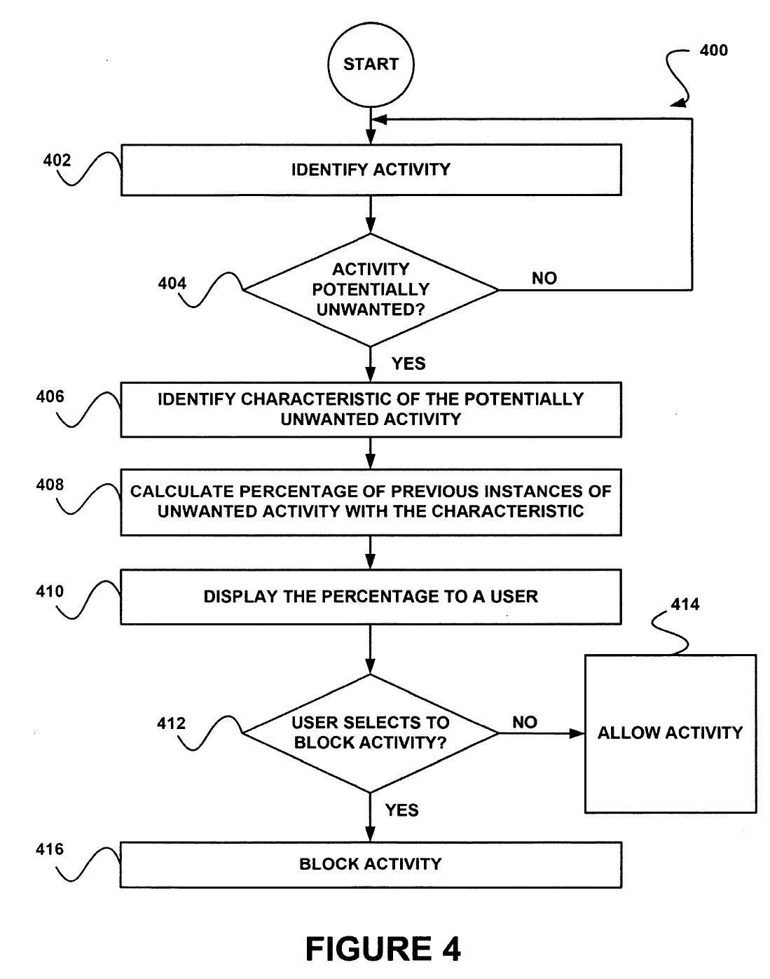

FIG. 4 illustrates a method for allowing or blocking a potentially unwanted activity based on an indication received by a user, in accordance with yet another embodiment. As an option, the method 400 may be carried out in the context of the architecture and environment of FIGS. 1-3. Of course, however, the method 400 may be carried out in any desired environment. It should also be noted that the aforementioned definitions may apply during the present description.

As shown in operation 402, an activity is identified. In one embodiment, the activity may be associated with an application. As an option, the application may initiate the activity. Further, as another option, the activity may include generating network requests, accessing a network address, accessing a network port, accessing memory, modifying memory, modifying a configuration (e.g. a configuration of a registry, a configuration file, or any other data stricture capable of including configuration settings), accessing a file, creating a file, modifying a file, deleting a file, launching an application, initiating a system call, configuring a service, starting a service, stopping a service, etc.

Further, in another embodiment, the activity may be identified by monitoring activity executing on a device. Thus, the monitoring may optionally identify any initiation an activity. For example, every activity initiated by the application may be monitored and thus identified. Still, in yet another embodiment, the application may be scanned to identify activities. As an option, the scanning may include decrypting the application, unpacking the application, inspecting the application, emulating the application, and/or sandboxing the application to identify activities initiated by the application.

As shown in decision 404, it is determined whether the activity is potentially unwanted. In one embodiment, a whitelist and/or blacklist may be utilized to determine if the activity is potentially unwanted. As an option, if an identifier of the application associated with the activity is included in the whitelist, then the activity may be determined to be a wanted activity.

Additionally, as yet another option, if the identifier of the application associated with the activity is included in the blacklist, then the activity may be determined to be an unwanted activity. Optionally, if the identifier of the application associated with the activity is not included in the whitelist and/or the blacklist, then the activity may be determined to be a potentially unwanted activity. Of course, however, the activity may be determined to be potentially unwanted in any desired manner.

Furthermore, in response to a determination that the activity is potentially unwanted, a characteristic of the potentially unwanted activity is identified. See operation 406. It should be noted that the characteristic of the potentially unwanted activity may include any attribute, feature, etc. of the potentially unwanted activity. Optionally, the characteristic may include at least one characteristic of the application associated with the potentially unwanted activity.

In one embodiment, characteristic of the application associated with the potentially unwanted activity may include a name and/or a type of a packer associated with the application. As an option, the packer may include any application and/or code utilized for compressing and/or decompressing the application. For example, the application may include decompression code associated with the packer, such that the packer may be identified via the decompression code. As another example, the packer may be used to compress original application code and combine the same with decompression code to form a single compressed application.

As another option, the packer name may identify a particular packer associated with the application. As another option, the packer type may identify a compression algorithm utilized. Still yet as another option, the packer type may identify a decompression technique and/or algorithm utilized.

In yet another embodiment, the characteristic of the application associated with the potentially unwanted activity may include a name and/or a type of a packager associated with the application. As an option, the packager associated with the application may archive and optionally compress the application. For example, the application may be archived utilizing a tape format archive (TAR), or any other technique of archiving the application.

As another example, the archived application may be compressed utilizing a compression technique such as bzip2, gzip, etc. Still, as yet another example, the application may be archived and compressed utilizing an archive and compression technique such as a cabinet, a disk image, a Roshal Archive (RAR), a ZIP, etc. Optionally, the name of the packager may include the name of the archive technique, and optionally the name of the compression technique utilized. Further, as yet another option, the type of the packager may indicate an archive packager, an archive and compress packager, etc.

In still another embodiment, the characteristic of the application associated with the potentially unwanted activity may include an indication of whether the application was created manually or created by a compiler. As an option, creating the application manually may include creating the application with a low level language such as an assembly language, or utilizing machine code. Further, as another option, creating the application by a compiler may include creating the application with a high level language. For example, the high level language may be compiled into the application using a compiler, and the low level language may be assembled and/or translated into the application using an assembler.

In yet another embodiment, the characteristic of the application associated with the potentially unwanted activity may include an origin of the application. As an option, the origin of the application may include the source of the application. For example, the origin of the application may include the company that created the application, the publisher who distributed the application, an individual who created the application, a name of the source of the application, a location of the application, etc.

Further, as yet another option, the origin of the application may be included in metadata associated with the application. Optionally, the metadata may indicate information associated with the origin of the application such as author, publisher, distributor, server, location, install source, etc. Furthermore, as an option, the origin of the application may be included in a signature associated with the application.

In another embodiment, the characteristic of the application associated with the potentially unwanted activity may include a time since the application was created. As an option, the time since the application was created may be determined based on a time stamp associated with the application. Optionally, the time stamp associated with the application may be compared against a current time stamp to determine the time that has elapsed since the application was created.

In yet another embodiment, the characteristic of the application associated with the potentially unwanted activity may include an amount of filler code associated with the application. As an option, the filler code may include non functional code associated with the application. For example, an application including code associated with the potentially unwanted activity may include filler code to try to hide and/or mask a presence of such code.

Further, as another option, the characteristic of the potentially unwanted activity may include at least one behavioral characteristic associated with the potentially unwanted activity. In one embodiment, the behavioral characteristic associated with the potentially unwanted activity may include a type of traffic (e.g. network traffic) generated by the potentially unwanted activity. As an option, the type of traffic generated may include traffic utilizing a protocol such as File Transfer Protocol (FTP), Hypertext Transfer Protocol (HTTP), Internet Relay Chat (IRC), Peer to Peer (P2P), Remote procedure call (RPC), Secure Shell (SSH), Simple Mail Transfer Protocol (SMTP), Simple Object Access Protocol (SOAP), Telecommunication Network (TELNET), any other standard protocol, and/or any proprietary protocol. Furthermore, as yet another option, the type of traffic may be identified based on address and/or port utilized by the potentially unwanted activity.

In another embodiment, the behavioral characteristic associated with the potentially unwanted activity may include a type of disk access generated by the potentially unwanted activity. As an option, the type of disk access generated may include accessing the disk via a driver or accessing the disk directly via an interrupt. Further, as yet another option, the type of disk access generated may include a read access request or a write access request.

In another embodiment, the behavioral characteristic associated with the potentially unwanted activity may include an attempt to launch an application, an attempt to terminate an application, etc. As an option, the behavioral characteristic may include a name of a launched and/or terminated application. Further, in yet another embodiment, the behavioral characteristic associated with the potentially unwanted activity may include an attempt to initiate a service. For example, attempting to initiate a service may include attempting to start the service, and/or scheduling the service to start. Of course, such behavioral characteristic may also include services initiated by the potentially unwanted activity.

In yet another embodiment, the behavioral characteristic associated with the potentially unwanted activity may include an attempt to modify or remove a previously configured service. Still yet, as another option, the behavioral characteristic associated with the potentially unwanted activity may include an attempt to terminate a currently executing service. Further, as an option, a name of the service modified, terminated, removed, etc.

In yet another embodiment, the behavioral characteristic associated with the potentially unwanted activity may include system configuration modifications associated with the potentially unwanted activity. As an option, the system configuration modifications may include a registry key modification, an initialization file modification, a file system modification, etc. For example, modifying the file system may include writing to a file, deleting a file, and/or modifying a sector associated with the file system.

In still yet another embodiment, the behavioral characteristic associated with the potentially unwanted activity may include a name of an application associated with memory space modified by the potentially unwanted activity. As another option, the behavioral characteristic may include a type of the application associated with the memory space modified by the potentially unwanted activity. For example, the potentially unwanted activity may modify the memory space associated with the application with new data and/or instructions.

As shown in operation 408, a percentage of previous instances of unwanted activity with the characteristic is calculated. In this way, the previous instances of unwanted activity may be associated with the characteristic of the potentially unwanted activity. As an option the previous instances of unwanted activity may include information associated with prior potentially unwanted activities identified and determined to be unwanted.

In one embodiment, the statistic may be calculated utilizing a table of predetermined characteristics. For example, the characteristic of the potentially unwanted activity may be compared to the predetermined characteristics. Each characteristic in the predetermined characteristics may be associated with a number of previous instances of each unwanted and wanted activities associated with such characteristic.

In this way, a predetermined characteristic matching the characteristic of the potentially unwanted activity may be identified, such that an associated number of previous instances of each unwanted and wanted activities may be identified. Further, the number of previous instances of unwanted activities and the number of previous instances of wanted activities may be utilized for calculating the percentage. Just by way of example, the number of previous instances of unwanted activities may be added to the number of previous instances of wanted activities, and the number of previous instances of unwanted activities may be divided by such sum for calculating the percentage of previous instances of unwanted activity with the characteristic.

In addition, the percentage is displayed to a user. See operation 410. As an option, the percentage may be displayed to the user utilizing a message (e.g. an alert, an email, a notification, etc.). Further, as yet another option, the message may allow the user to select to block or allow the potentially unwanted activity.

Furthermore, as shown in decision 412, it is determined whether the user selects to block the activity. Optionally, such selection may be made via the message displayed to the user. If it is determined that the user does not select to block the potentially unwanted activity, the activity is allowed. See operation 414. For example, allowing the activity may allow the activity to continue. As an option, it may be determined that the user does not select to block the activity if the user selects an option to allow the activity. However, if it is determined that the user selects to block the potentially unwanted activity, the activity is blocked. See operation 416. For example, blocking the activity may terminate and/or stop the activity.

In another embodiment, the number of previous instances of wanted activity with the characteristic or unwanted activity with the characteristic may be updated, based on the user selection. For example, if the user selects to block the potentially unwanted activity, the number of previous instances of unwanted activity with the characteristic may be incremented. If, however, the user does not select to block the potentially unwanted activity, the number of previous instances of wanted activity with the characteristic may be incremented.

Furthermore, as an option, any additional characteristics of the potentially unwanted activity may be sent to a database, based on the user selection. Optionally, the database may be centrally managed by a software provider. Additionally, as another option, the software provider may utilize the database to create and/or update the predetermined characteristics. As yet another option, the software provider may utilize the database for trending, analysis, reporting etc. In this way, characteristics associated with potentially unwanted activity selected by a user to be blocked or allowed may be stored for comparison with subsequent instances of identified potentially unwanted activity.

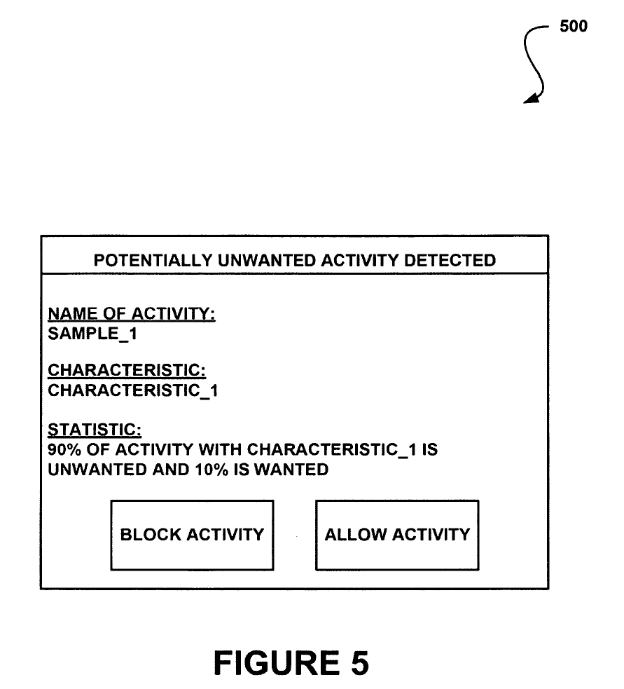

FIG. 5 illustrates a graphical user interface 500 for displaying a message associated with a potentially unwanted activity to a user, in accordance with still yet another embodiment. As an option, the graphical user interface 500 may be implemented in the context of the architecture and environment of FIGS. 1-4. For example, the graphical user interface 500 may be implemented for carrying out operation 410 of FIG. 4. Of course, however, the graphical user interface 500 may be implemented in any desired environment. Again, it should be noted that the aforementioned definitions may apply during the present description.

In one embodiment, the graphical user interface (GUI) 500 may include a window for displaying information relating to an identified potentially unwanted activity. Furthermore, in another embodiment, the window may be utilized for receiving an indication from a user of whether the potentially unwanted activity is to be blocked or allowed. The GUI 500 may be displayed on any desired device capable of displaying the GUI 500. For example, the GUI 500 may be displayed on a client device (e.g. such as the client 106 of FIG. 1).

As shown, the GUI 500 includes a title that may indicate that a potentially unwanted activity is detected. Furthermore, the GUI 500 may include a plurality of fields for displaying information associated with the potentially unwanted activity. As an option, the fields may present a name of the potentially unwanted activity. As another option, the fields may present at least one characteristic of the potentially unwanted activity.

Still yet, as another option, the fields may present at least one statistic associated with the characteristic. For example, the statistic may include a percentage of previous instances of unwanted activity with the characteristic and/or a percentage of previous instances of wanted activity with the characteristic. In addition, as yet another option, the fields may include a statistic associated with each characteristic of the potentially unwanted activity. Further, the statistic may include an aggregated statistic associated with a statistic for each of the characteristics.

In addition, the GUI 500 may include a prompt. As an option, the prompt may allow the user to indicate whether to block the potentially unwanted activity or to allow the potentially unwanted activity. In another embodiment, the prompt of the GUI 500 may include a first option (e.g. a graphical user interface control) that may allow the user to indicate that the potentially unwanted activity is be blocked and second option that may allow the user to indicate that the potentially unwanted activity is be allowed. For example, the graphical user interface controls may include at least one button, checkbox, radio button, drop list, drop down, text box, input, image, etc.

Still yet, in another embodiment, the GUI 500 may be color coded. As an option, the color coding may be based on the statistic. For example, the color coding may utilize two colors such as red and green. In the context of the current example, if a statistic associated with a percentage of unwanted activity is greater than a predetermined threshold, then the color coding may be red, and if the statistic associated with the percentage of unwanted activity is less than the predetermined threshold, then the color coding may be green. However, it should be noted that any number of colors may be utilized in addition to any number of thresholds for indicating the color. As another option, the GUI 500 may include a graph and/or a pictorial representation of the at least one statistic.

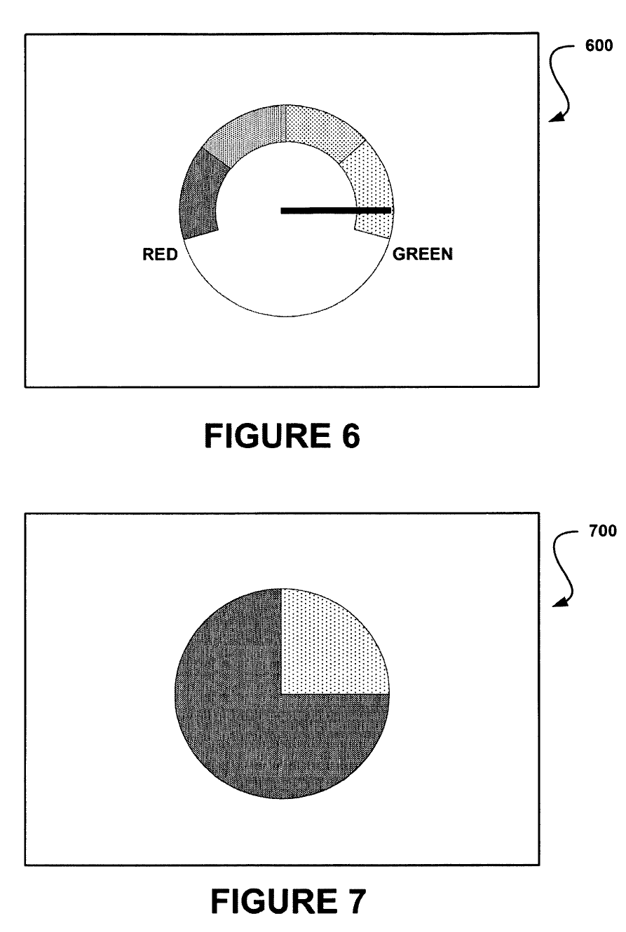

FIG. 6 illustrates a pictorial representation 600 indicating at least one statistic associated with a potentially unwanted activity, in accordance with another embodiment. As an option, the pictorial representation 600 may be implemented in the context of the architecture and environment of FIGS. 1-5. Of course, however, the pictorial representation 600 may be implemented in any desired environment. Again, it should be noted that the aforementioned definitions may apply during the present description.

In one embodiment, the pictorial representation 600 may include a graphic of a statistic associated with of the potentially unwanted activity. As an option, the graphic may represent a percentage that previous instances of activity with the same characteristic of the potentially unwanted activity were unwanted and/or wanted. Optionally, the graphic may include a color coded range of color values corresponding to the statistic.

For example, the graphic may include a range of color values with 0% wanted indicated by the color red, and 100% wanted indicated by the color green. In the context of the current example, the intermediate percentage values may be indicated by the intermediate colors between red and green. As an option, the percentage may be represented by a line overlaid on top of the color coded range of values. As yet another option, the graphic may include a circular graphic, a bar graphic, a rectangular graphic, an abstract graphic, or any other graphic capable of indicating the statistic.

FIG. 7 illustrates a graph 700 indicating at least one statistic of a potentially unwanted activity to a user, in accordance with yet another embodiment. As an option, the graph 7700 may be implemented in the context of the architecture and environment of FIGS. 1-6. Of course, however, the graph 7700 may be implemented in any desired environment. Yet again, it should be noted that the aforementioned definitions may apply during the present description.

In one embodiment, the graph 700 may include a representation of at least one statistic associated with potentially unwanted activity. As an option, the graph 700 may include any chart such as a pie chart, a bar graph, a histogram, a line chart, a scatterplot, etc. Optionally, the graph 700 may include a section associated with a percentage of previous instances of activity with the characteristic determined to be wanted. Further, the graph 700 may include a section associated with a percentage of previous instances of activity with the characteristic determined to be unwanted.

For example, a pie chart may indicate that previous instances of activity with the characteristic of the potentially unwanted activity is 75% unwanted and 25% wanted. Still yet, as another option, the graph 700 may be color coded. As an option, the section associated with the unwanted activity may be color coded red and/or the section associated with the wanted activity may be color coded green. Furthermore, as yet another option, the graph 700 may include a legend indicating the color coding for each section of the chart. Optionally, the graph 700 may include any number of sections and colors relating to the statistic associated with the potentially unwanted activity.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A computer program product embodied on a non-transitory computer readable medium, comprising instructions to cause a programmable processor to
identify a potentially unwanted activity without regard to an application associated with the potentially unwanted activity;
identify a characteristic associated with the identified potentially unwanted activity;
determine a statistic indicating a ratio of wanted activity relative to unwanted activity associated with the identified characteristic;
provide a graphical user interface to display the statistic and information pertaining to the identified characteristic; and
receive a selection from a selection choice in the a graphical user interface, the selection choice indicating to allow or block the identified potentially unwanted activity.

2. The computer program product of claim 1, wherein the instructions to cause the programmable processor to identify the potentially unwanted activity comprise instructions to cause the programmable processor to identify the potentially unwanted activity via at least one of signature scanning, heuristics, blacklisting, and whitelisting.

3. The computer program product of claim 1, wherein the instructions to cause the programmable processor to identify the potentially unwanted activity comprise instructions to cause the programmable processor to identify potentially unwanted activity initiated by an application.

4. The computer program product of claim 3, wherein the instructions to cause the programmable processor to identify the characteristic comprise instructions to cause the programmable processor to identify a characteristic of the application.

5. The computer program product of claim 4, wherein the instructions to cause the programmable processor to identify the characteristic of the application comprise instructions to cause the programmable processor to identify at least one of a name of a packer associated with the application, a type of the packer associated with the application, a name of a packager associated with the application, a type of the packager associated with the application, whether the application was created by a compiler or manually created, an origin of the application, a time since the application was created, and an amount of filler code associated with the application.

6. The computer program product of claim 1, wherein the instructions to cause the programmable processor to identify the characteristic comprise instructions to cause the programmable processor to identify a behavioral characteristic of the identified potentially unwanted activity.

7. The computer program product of claim 6, wherein the instructions to cause the programmable processor to identify the behavioral characteristic of the identified potentially unwanted activity comprise instructions to cause the programmable processor to identify at least one of a type of traffic generated by the potentially unwanted activity, a type of disk access generated by the potentially unwanted activity, a name of an application launched by the potentially unwanted activity, system configuration modifications associated with the potentially unwanted activity, services initiated by the potentially unwanted activity, a name of an application associated with memory space modified by the potentially unwanted activity, and a type of the application associated with the memory space modified by the potentially unwanted activity.

8. The computer program product of claim 6, wherein the instructions to cause the programmable processor to identify the behavioral characteristic of the identified potentially unwanted activity comprise instructions to cause the programmable processor to identify a type of traffic generated by the potentially unwanted activity, the type of traffic including at least one of Internet Relay Chat (IRC), Hypertext Transfer Protocol (HTTP), File Transfer Protocol (FTP), Telecommunication Network (TELNET), and Secure Shell (SSH).

9. The computer program product of claim 6, wherein the instructions to cause the programmable processor to identify the behavioral characteristic of the identified potentially unwanted activity comprise instructions to cause the programmable processor to identify system configuration modifications associated with the potentially unwanted activity, the system configuration modifications including at least one of a registry key modification, an initialization file modification, and a file system modification.

10. The computer program product of claim 1, wherein the instructions to cause the programmable processor to determine the statistic comprise instructions to cause the programmable processor to calculate the statistic based on previous instances of unwanted activity associated with the characteristic.

11. The computer program product of claim 1, wherein the statistic comprises a percentage of previous instances in which the characteristic was associated with unwanted activity.

12-15. (canceled)

16. The computer program product of claim 1, wherein the instructions to cause the programmable processor to provide the graphical user interface comprise instructions to cause the programmable processor to provide a graph of the statistic in the graphical user interface.

17. The computer program product of claim 1, wherein the instructions to cause the programmable processor to provide the graphical user interface comprise instructions to cause the programmable processor to provide a pictorial representation of the statistic in the graphical user interface.

18. A method, comprising:
identifying, with a processor, a potentially unwanted activity without regard to an application associated with the potentially unwanted activity;
identifying, with the processor, a characteristic associated with the identified potentially unwanted activity;
determining, with the processor, a statistic indicating a ratio of wanted activity relative to unwanted activity associated with the identified characteristic;
providing, with the processor, a graphical user interface configured to display the statistic information pertaining to the identified characteristic; and
receive a selection from a selection choice in the graphical user interface, the selection choice indicating to allow or block the identified potentially unwanted activity.

19. A system, comprising:
a memory; and
one or more processors communicatively coupled to the memory, the memory having stored therein instructions to cause the one or more processors to identify a potentially unwanted activity without regard to an application associated with the potentially unwanted activity, identify a characteristic associated with the identified potentially unwanted activity, determine a statistic indicating a ratio of wanted activity relative to unwanted activity associated with the identified characteristic, provide a user interface configured to display the statistic and information pertaining to the identified characteristic, and receive a selection from a user selection choice in the graphical user interface, the selection choice indicating to allow or block the identified potentially unwanted activity.

20. (canceled)
